(19) United States
(12) Patent Application Publication
(10) Pub. No.: US 2011/0119749 A1
(43) Pub. Date: May 19, 2011

(54) SYSTEM AND METHOD FOR FILTERING SIP-BASED SPAM

(75) Inventors: So Yung Park, Daejeon (KR); Sung Hei Kim, Daejeon (KR); Shin Gak Kang, Daejeon (KR)

(73) Assignee: ELECTRONICS AND TELECOMMUNICATIOS RESEARCH INSTITU, Daejeon (KR)

(21) Appl. No.: 12/674,937

(22) PCT Filed: Aug. 20, 2008
(86) PCT No.: PCT/KR2008/004844

§ 371 Date: Feb. 24, 2010

(30) Foreign Application Priority Data
Sep. 5, 2007 (KR) 10-2007-0089953

(51) Int. Cl. G06F 21/00; G06F 15/16

(52) U.S. Cl. 726/12; 726/13

(57) ABSTRACT

A system for filtering SIP (Session Initiation Protocol)-based spam includes a spam detection unit for receiving a SIP message where labeling is performed from a sending user agent and detecting the spam using a label in the SIP message. Further, the system includes a spam checking unit for checking a call recipient from the SIP message and confirming a spam policy previously set by the call recipient through a spam management server; and a spam filtering unit for filtering the spam based on the confirmed spam policy.

### CROSS-REFERENCE TO RELATED APPLICATIONS

The present invention claims priority of Korean Patent Application No. 10-2007-0089953, filed on Sep. 5, 2007, which is incorporated herein by reference.

### TECHNICAL FIELD

The present invention relates to a system and method for filtering Session Initiation Protocol (hereinafter, referred to as “SIP”) based spam; and, more particularly, to a system and method for detecting a spam call by analyzing a SIP message transmitted to establish a call session and for filtering spam according to a spam policy previously set by a call recipient.

This work was supported by the IT R&D program of MIC/IITA [2007-P10-41, Study on Standardization of Public Safety for IP Applications].

### BACKGROUND ART

As well known, spam is defined as bulk unsolicited commercial mail. Massive spam mail causes harm to many service users and, in particular, mobile phone service users suffer from mobile phone Short Message Service (hereinafter, referred to as “SMS”) spam since mobile phones became popular.

Further, as Internet Protocol (hereinafter, referred to as “IP”) application services such as internet phones, internet connections and instant messaging are developing, spam based on IP application services is emerging as a new threat. Of spam based on the IP application services, Spam over Instant messaging (hereinafter, referred to as “SPIM”) and Spam over Internet Telephony (hereinafter, referred to as “SPIT”) have become the main issue.

That is, there are significant differences in technical characteristics between spam based on IP application services and email spam. For example, a large part of IP application services such as internet phones are provided in real time and service contents may include multimedia as well as text. Further, users can use several IP supplementary services at the same time while using a main IP application service.

However, according to the conventional techniques, once spam occurs, a spam recipient has to waste time and efforts to detect or delete spam and the spam occupies a storage space of an internet telephony terminal. Further, illegal and scam spam can cause material/mental harm, so that damage that IP application service users can get may be much more than damage that email spam can cause. Furthermore, IP application services have security weakness due to IP network characteristics, which allows a variety of spam generation methods. Besides, there are technical problems to find and deal with the spam.

On the other hand, since an consensus for the requirement to prevent a threat of IP application service spam was established, research to cope with IP application service spam has been performed. However, due to the technical characteristics of IP application service spam, it is quite difficult to apply the solution for the email spam to the IP application service spam.

In addition, since IP application services include not only text but also multimedia contents, which is unlike email, detecting interne telephony spam requires significant efforts and spam filtering may put extra load on network equipment and service user terminals.

### DISCLOSURE OF INVENTION

### Technical Problem

In view of the above, the present invention provides a SIP-based spam filtering system and method for detecting a spam call by analyzing a SIP message transmitted in order to establish a call session and for filtering spam according to a spam policy previously set by a call recipient.

### Technical Solution

In accordance with an aspect of the present invention, there is provided a system for filtering SIP (Session Initiation Protocol)-based spam including: a spam detection unit for receiving a SIP message where labeling is performed from a sending user agent and detecting the spam using a label in the SIP message; a spam checking unit for checking a call recipient from the SIP message and confirming a spam policy previously set by the call recipient through a spam management server; and a spam filtering unit for filtering the spam based on the confirmed spam policy.

In accordance with another aspect of the present invention, there is provided a method for filtering SIP-based spam including: generating and transmitting a SIP message where labeling is performed in case of a spam mode; managing a spam policy previously set by a recipient user agent; and if the spam is detected from the SIP message where labeling is performed, filtering a spam call based on the previously set spam policy.

In the present invention, a spam call is detected by analyzing the SIP message transmitted to establish a call session and spam is filtered out according to the spam policy previously set by the call recipient, thereby minimizing damage caused by internet telephony spam on the SIP network.

### BRIEF DESCRIPTION OF THE DRAWINGS

The objects and features of the present invention will become apparent from the following description of embodiments given in conjunction with the accompanying drawings, in which:

FIG. 1 is a block diagram of a basic network for a system for filtering SIP-based spam in accordance with the embodiment of the present invention;

FIG. 2 is a detailed block diagram of a network for a system for filtering SIP-based spam in accordance with the embodiment of the present invention;

FIG. 3 is a detailed flow chart for describing a process for inserting a label into a SIP message;

FIG. 4 is a structure diagram of a SIP message where labeling is performed;

FIG. 5 is a detailed flow chart for describing a process in a recipient proxy server in accordance with the embodiment of the present invention; and

FIG. 6 is a detailed flow chart for describing a process in a recipient proxy server in accordance with another embodiment of the present invention.

### BEST MODE FOR CARRYING OUT THE INVENTION

Hereinafter, embodiments of the present invention will be described in detail with reference to the accompanying drawings which form a part hereof.

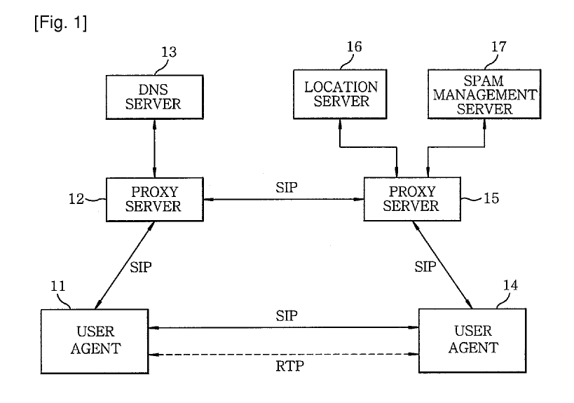

FIG. 1 is a block diagram of a basic network for a system for filtering SIP-based spam in accordance with the present invention. The network includes user agents 11 and 14, proxy servers 12 and 15, a Domain Name System (hereinafter, referred to as “DNS” server 13, a location server 16 and a spam management server 17.

For example, the user agent 11 is assumed as a caller, e.g., a spammer sending spam and the user agent 14 is assumed as a call recipient, e.g., a spam recipient using internet telephony services and receiving spam.

The proxy servers 12 and 15 handle SIP message routing between the user agents 11 and 14.

The DNS server 13 and the location server 16 are databases that supply information to the proxy servers 12 and 15 in order to effectively provide internet telephony services.

The spam management server 17 connected to the proxy server 15 is to manage spam.

The user agents 11 and 14 and the proxy servers 12 and 15 communicate with each other by using SIP, while both communication between the user agents 11 and 14 to establish a session and communication between the proxy servers 12 and 15 are performed by using SIP. However, real-time media communication between the user agents 11 and 14 is done by Real-Time Protocol (hereinafter, referred to as “RTP”).

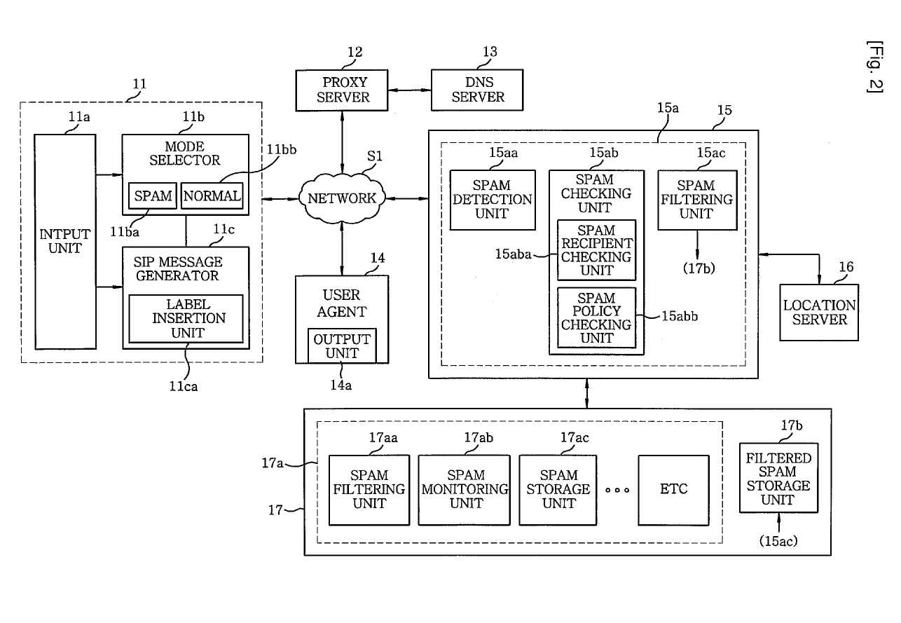

FIG. 2 is a block diagram of a detailed network for a system for filtering SIP-based spam in accordance with the embodiment of the present invention. The network includes the user agents 11 and 14, the proxy servers 12 and 15, the DNS server 13, the location server 16 and the spam management server 17.

The user agent 11 includes an input unit 11a, a mode selector 11b and SIP message generator 11c.

An input is fed through the input unit 11a to select a mode of the mode selector 11b and to generate SIP messages. For example, the input unit 11a refers to input buttons on the telephone and an input unit for the mode selector 11b and an input unit for the SIP message generator 11c do not need to be physically the same.

The mode selector 11b serves to select either a spam mode 11ba or a normal mode 11bb depending on the input from the input unit 11a. Since the user agent 11 may not be used for generating spam, the mode selector 116 selects the mode in order to determine whether to insert a label.

The SIP message generator 11c has a label insertion unit 11ca and checks the mode selected by the mode selector 11b in order to connect a session by using SIP. In case of the spam mode 11ba, the SIP message generator 11c transmits a SIP message generated by the input of the input unit 11a to the proxy servers 12 and 15 through a network S1. At that time, a label is inserted into the SIP message by the label insertion unit 1 lca so that it can be used to detect internet telephony spam.

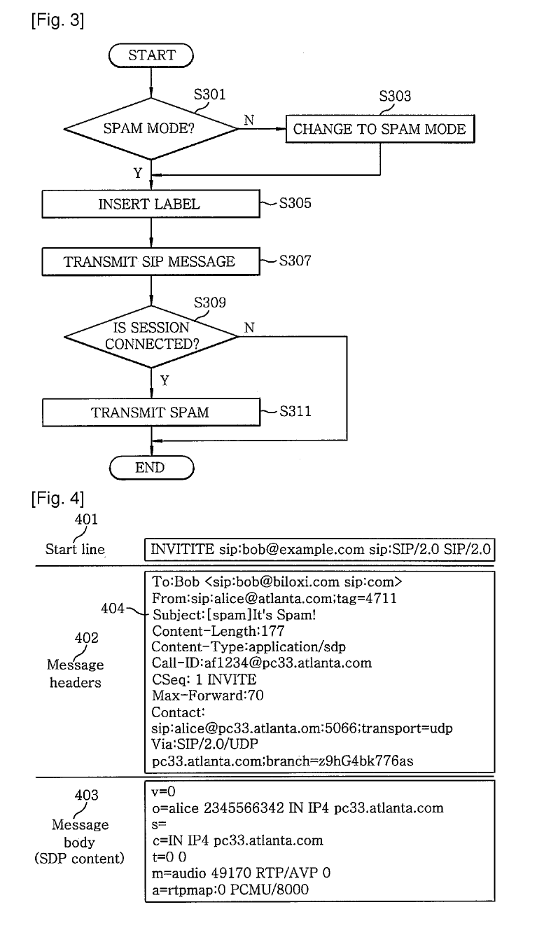

To be more specific, a process for inserting a label into a SIP message will be described with reference to FIG. 3. First, once a spam call is transmitted, the SIP message generator 11c checks whether the transmission mode of the mode selector 11b is a spam mode 11ba or not (step S301). In case of the normal mode 11bb, the transmission mode is switched to the spam mode 11ba (step S303). If the result of step S301 indicates the spam mode 11ba, a SIP message is generated in the current spam mode 11ba. At that time, a label of an agreed phrase is inserted into the SIP message (step S305). Then, the SIP message where labeling is performed, e.g., as shown in FIG. 4, is transmitted to the proxy servers 12 and 15 through the network S1 (step S307) and whether a session is connected is checked (step S309). If the session is not connected according to step S309, the process is terminated. In contrast, if the session is connected, spam is transmitted to the proxy servers 12 and 15 through the network S1 (step S311).

Herein, the SIP message where labeling is performed may include a start line 401, a message header 402 and a message body 403 as shown in FIG. 4. Each field of the message header 402 has various information necessary for message transmission and the SIP message may also include agreed text indicating spam such as a label. For example, agreed text indicating spam, e.g., [spam], is inserted into a subject field 404 of the message header 402 and therefore the recipient proxy server 15 or user agent 14 checks the agreed text in the SIP message to thereby confirm that the current session is for spam call transmission.

Further, while contents of the label inserted into the SIP message are agreed in advance, they may be nationally agreed text indicating spam or may be text agreed between internet telephony service providers. There is no limitation in the agreement of the text contained in the label.

The proxy server 12 serving as a transmission server transmits the SIP message where labeling is completed, which is fed from the user agent 11 through the network S1, to the proxy server 15 serving as a recipient server by referring to the recipient DNS stored in a database of the DNS server 13.

The proxy server 15 serving as a recipient server is formed of a spam management unit 15a and uses a database of the location server 16. The spam management unit 15a includes a spam detection unit 15aa, a spam checking unit 15ab and a spam filtering unit 15ac, and the proxy server 15.

The spam detection unit 15aa detects whether the label of the SIP message fed through the network S1 contains agreed text indicating spam and, if there is agreed text, the SIP message is detected as spam. Otherwise, the SIP message is detected as non-spam.

The spam checking unit 15ab includes a spam recipient checking unit 15aba and a spam policy checking unit 15abb. The spam recipient checking unit 15aba checks information of the user agent 14 serving as a call recipient from the SIP message. The spam policy checking unit 15abb requests that the spam management server 17 check a spam policy of the user agent 14 confirmed by the spam recipient checking unit 15aba, receives the spam policy from the spam management server 17 and then transmits it to the spam filtering unit 15ac.

If the user agent 14 wants to store spam according to the spam policy checked by the spam checking unit 15ab, the spam filtering unit 15ac stores the filtered spam in a filtered spam storage unit 17b of the spam management server 17. On the contrary, if the user agent 14 does not want a session connection according to the spam policy checked by the spam checking unit 15ab, the spam filtering unit 15ac refuses the session connection and terminates the communication.

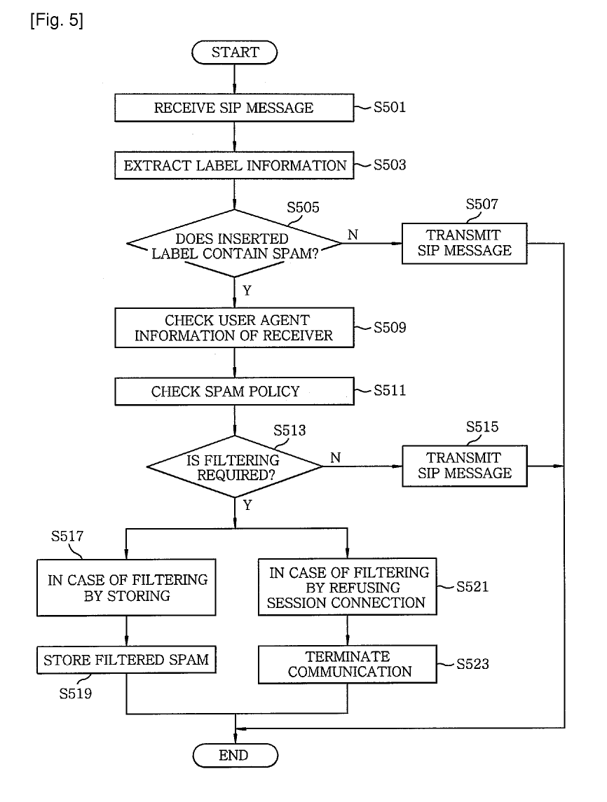

A process in the proxy server 15 in accordance with the embodiment of the present invention will be described in detail with reference to FIG. 5. If a SIP message for voice call transmission is fed to the spam detection unit 15aa of the spam management unit 15a (step S501), label information is extracted from the SIP message (step S503) and then whether there is a label with agreed text indicating spam is checked (step S505).

According to the result of step S505, if there is no label with the text, the SIP message is transmitted to the user agent 14 in the same manner as normal calls (step S507). On the contrary, if there is a label with inserted text, the spam recipient checking unit 15aba in the spam checking unit 15ab checks information of the call recipient user agent 14 from the SIP message (step S509).

Thereafter, by using the information of the confirmed user agent 14, the spam policy checking unit 15abb inquires of the spam management server 17 about a spam policy of the user agent 14 (step S511). According to the spam policy of the user agent 14 serving as a call recipient, whether spam filtering is requested or not is determined (step S513).

According to the result of step S513, if filtering is not requested, the SIP message is sent to the user agent 14 like normal calls (step S515). If filtering is requested, the corresponding filtering is performed on the spam call.

That is, if the user agent 14 wants to store the filtered spam (step S517), it allows a session connection and then the spam filtered by the spam filtering unit 15ac is stored in the filtered spam storage unit 17b in the spam management server 17 (step S519). On the other hand, if the user agent 14 does not want to allow a session connection (step S521), the spam filtering unit 15ac refuses the session connection and terminates the communication (step S523).

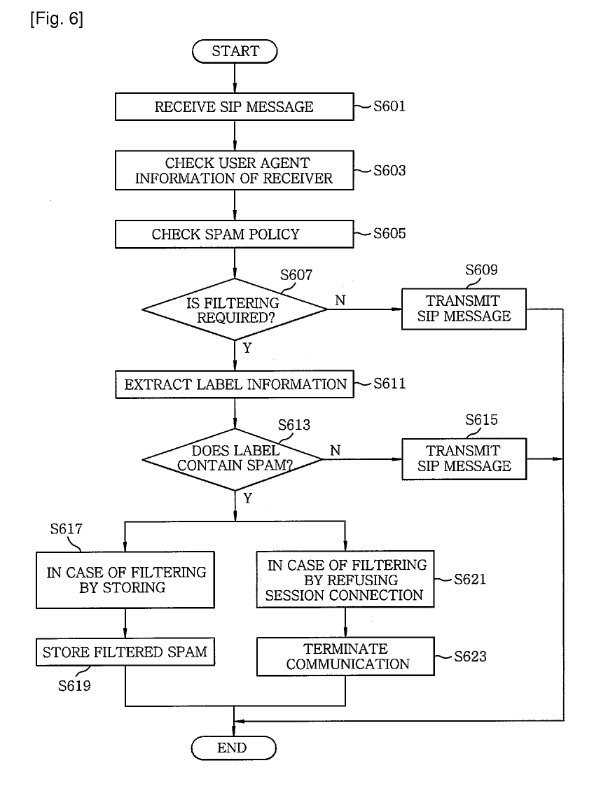

A process in the proxy server 15 in accordance with another embodiment of the present invention will be described in detail with reference to FIG. 6. If a SIP message for voice call transmission is fed to the spam detection unit 15aa of the spam management unit 15a (step S601), the spam recipient checking unit 15aba of the spam checking unit 15ab checks information of the call recipient user agent 14 from the SIP message (step S603).

Thereafter, by using the information of the confirmed user agent 14, the spam policy checking unit 15abb inquires of the spam management server 17 about a spam policy of the user agent 14 (step S605). According to the spam policy of the user agent 14 serving as a call recipient, whether spam filtering is requested or not is determined (step S607).

According to the result of step S607, if filtering is not requested, the SIP message is sent to the user agent 14 like normal calls (step S609). If filtering is requested, it needs to be confirmed that the session is for transmission of a spam call. Therefore, label information is extracted from the SIP message (step S611) and whether there is agreed text indicating spam in the inserted label is then checked (step S613).

According to the result of step S613, if there is no text in the inserted label, the SIP message is transmitted to the user agent 14 in the same manner as normal calls (step S615). However, if the inserted label contains text, the spam call is filtered out according to the spam policy set by the call recipient user agent 14.

That is, if the user agent 14 wants to store the filtered spam (step S617), it allows a session connection and then the spam filtered by the spam filtering unit 15ac is stored in the filtered spam storage unit 17b in the spam management server 17 (step S619). On the other hand, if the user agent 14 does not want to allow a session connection (step S621), the spam filtering unit 15ac refuses the session connection and terminates the communication (step S623).

The spam management server 17 deals with various spam policies previously set by the call recipient and it includes a spam policy management unit 17a and the filtered spam storage unit 17b.

The spam policy management unit 17a has a spam filtering unit 17aa, a spam monitoring unit 17ab and a spam storage unit 17ac.

The spam filtering unit 17aa manages spam filtering policies according to the spam policies previously set by the call recipient user agent 14 such that a session connection is refused, a spam call is transmitted like a normal call and the spam is stored not in the call recipient user agent 14 but in the filtered spam storage unit 17b of the spam management server 17.

The spam monitoring unit 17ab manages spam monitoring policies previously set by the call recipient user agent 14 such that spam reception is monitored or is required to be reported to the user agent 14.

The spam storage unit 17ac stores the spam policies about the storage of the filtered spam which are previously set by the call recipient user agent 14.

The filtered spam storage unit 17b stores filtered spam fed from the spam filtering unit 15ac in the proxy server 15.

On the other hand, according to the process result of the proxy server 15, a spam call is transmitted to the call recipient user agent 14 or the spam filtering result is reported to the user agent 14 by the internet telephony service providers. The spam filtering result is outputted through an output unit 14a in the user agent 14 so that the call recipient can confirm. Further, the call recipient user agent 14 may properly store various desired spam policies into the spam filtering unit 17aa, spam monitoring unit 17ab or spam storage unit 17ac in the spam management server 17.

Accordingly, in accordance with the present invention, a spam call is detected by analyzing the SIP message transmitted in order to establish a call session and spam is filtered out according to the spam policy previously set by the call recipient so that damage caused by internet telephony spam on the SIP network can be reduced.

While the invention has been shown and described with respect to the embodiments, it will be understood by those skilled in the art that various changes and modifications may be made without departing from the scope of the invention as defined in the following claims.

1. A system for filtering SIP (Session Initiation Protocol)-based spam comprising:
a spam detection unit for receiving a SIP message where labeling is performed from a sending user agent and detecting the spam using a label in the SIP message;
a spam checking unit for checking a call recipient from the SIP message and confirming a spam policy previously set by the call recipient through a spam management server; and
a spam filtering unit for filtering the spam based on the confirmed spam policy.

2. The system of claim 1, wherein the sending user agent has a mode selector for selecting a spam mode or a normal mode and a SIP message generator for generating and transmitting the SIP message where labeling is performed to the spam detecting unit in case of the spam mode.

3. The system of claim 2, wherein the SIP message where labeling is performed includes a start line, a message header and a message body and wherein the message header has an agreed text indicating spam inserted in its subject field.

4. The system of claim 1, wherein if the confirmed spam policy addresses the storage of spam, the spam filtering unit stores the filtered spam in a filtered spam storage unit of the spam management server.

5. The system of claim 1, wherein if the confirmed spam policy is set to break off a session connection, the spam filtering unit refuses a session connection and terminates the communication.

6. A method for filtering SIP-based spam comprising:
generating and transmitting a SIP message where labeling is performed in case of a spam mode;
managing a spam policy previously set by a recipient user agent; and
if the spam is detected from the SIP message where labeling is performed, filtering a spam call based on the previously set spam policy.

7. The method of claim 6, wherein filtering the spam call includes:
detecting the spam using a label inserted into the SIP message;
checking information of a call recipient from the SIP message and confirming the spam policy corresponding to the checked information of the call recipient; and
if the confirmed spam policy addresses the storage of spam, filtering the spam and storing it in a filtered spam storage unit of a spam management server.

8. The method of claim 7, wherein if the confirmed spam policy is set to break off a session connection, the session connection is refused and the communication is terminated.

9. The method of claim 6, wherein filtering the spam call includes:
receiving the SIP message;
checking information of a call recipient from the SIP message and confirming a spam policy corresponding to the information of the confirmed call recipient;
if the confirmed spam policy addresses filtering, detecting the spam using a label inserted into the SIP message; and
if the spam is detected, filtering the spam and storing it in a filtered spam storage unit of a spam management server.

10. The method of claim 6, wherein generating and transmitting the SIP message includes:
checking whether in a spam mode;
in case of a normal mode, switching the normal mode to the spam mode;
in case of the spam mode, inserting a label into the SIP message;
transmitting the SIP message containing the label to a recipient proxy server; and
transmitting the spam to the recipient proxy server while a session is connected.
